(19) United States
(12) Patent Application Publication
(10) Pub. No.: US 2003/0081816 A1
(43) Pub. Date: May 1, 2003

(54) System and service for providing three-dimensional images of prenatal mammals

(75) Inventors: Jong-Hwan Jun, Cresskill, NJ (US); Seong-Woo Lee, Seoul (KR)

Correspondence Address: MORGAN LEWIS & BOCKIUS LLP, 1111 PENNSYLVANIA AVENUE NW, WASHINGTON, DC, 20004, US

(73) Assignee: FETAL IMAGING SERVICES, INC.

(21) Appl. No.: 09/983,873

(22) Filed: Oct. 26, 2001

(51) Int. Cl. G06K 9/00

(52) U.S. Cl. 382/110; 382/154

(57) ABSTRACT

The present invention discloses a method and system for providing three-dimensional images of prenatal mammals including the steps of scanning an expectant mother to obtain the three-dimensional images of the prenatal mammal at a non-medical facility, storing the three-dimensional images into a storage medium, and providing the three-dimensional images stored in the storage medium to a customer or the expectant mother.

### BACKGROUND OF THE INVENITON

1. Field of the Invention

The present invention relates to a method for providing images taken from a customer, more particularly to a system and method for providing three-dimensional images of prenatal mammals. An ultrasonic diagnostic device obtains the images of prenatal mammals and produces a three-dimensional image from the ultrasonic information. Further, an article containing the three-dimensional image may also be created for the customer in the present invention.

2. Discussion of the Related Art

Methods and apparatuses for processing and obtaining two and three-dimensional images of an article or an individual are commercially available. For example, coin or bill operated photo-finishing booths having fixed lens cameras therein take a series of photographs of an individual sitting in the booth, and are developed in the machine and dispensed to the individual.

Other conventional photography booths include a video-photo installation that produces a photographic montage using a real time image of a subject-user of the installation and a stored image selected by the subject-user. In such photography booths, a sensor registers the position of the subject-user and adjusts that position as needed. A control enables the installation to be controlled by the subject-user in accordance with instructions provided by the installation. The control may be executed by touch screen and audio/visual units that have multilingual capacity may effect communication with the user. Cosmetic features or messages may also be added to the image. The advantage of such system is that it is user-friendly and can superimpose one image on top of another image.

Another form of obtaining a two-dimensional image of an object or individual involves consumers exposing a roll of film, and delivering the roll to the photofinisher with instructions on the number and size of prints. The photofinisher then develops the film, prints the photographs, and returns the photographs along with the developed film to the consumer. Thus, the consumer cannot decide, prior to developing the film or viewing the negatives, how many photographs to purchase regardless of the quality or content of a particular exposure. To obtain additional prints the consumer must return the proper negative to the photofinisher for reprinting.

Photofinisher's have recently developed index prints to enable consumers to easily order reprints. Index prints are a single print containing a small image often called a thumbnail of each negative in the roll of film. Index prints, may be created by digitizing each image, shrinking and combining the digitized images, and printing the single combined image. Index prints make it easier to retrieve particular images from storage and facilitate ordering reprints since the customer can quickly view a single print to determine whether a particular image was photographed on a given roll of film and if so, which exposure must be reprinted.

Another service photofinishers provide customers, is an electronic copy of their finished photographs, either on a magnetic floppy disk or an optical CDROM. Electronic copies of the photographs may easily be incorporated into other electronic material. For example, photographs may be inserted in text-based documents or attached to email messages. Furthermore, many photographs may be compiled on a single CDROM, greatly reducing the amount of storage space required to store the photographs. Additionally, CDROM's are relatively durable and endure temperature and humidity extremes that would destroy traditional photographs.

Electronic copies are also used as an intermediate product to facilitate ordering initial prints. Some photofinishers, especially mail-order photofinishers, now develop film and scan each negative. The scanned images are then posted on the Internet or sent as private email to allow the customer to preview the images. The customer then orders a desired number of prints of each image. This method avoids printing images the customer does not want, and allows the customer who desires many copies of an image to proof the image before committing to purchase the copies.

As for machines and methods for producing three-dimensional images, many applications use a series of two-dimensional drawings or photographs first made of three-dimensional drawings, and then each of those drawings are passed through a conventional flatbed scanner that then sends signals to a computer. Through suitable software various two or three-dimensional images are developed on a monitor screen and/or printed out by a conventional printer.

Other imaging processes employ cameras which rotate slowly about a three-dimensional object and signals from those cameras are fed into suitable computers to produce two or three-dimensional images of the three-dimensional object. Still other systems employ laser and video based technology to scan a three-dimensional object and then feed that information to suitable computer operated equipment to produce two or three-dimensional reproductions of the three-dimensional object.

However, the above mentioned methods and systems are restricted to obtaining images of objects that are visible to the naked eye.

Accordingly, there is a need in the art, to create, process, modify and produce a three-dimensional image of a prenatal mammal and an article containing the image of the prenatal mammal by using an ultrasonic diagnostic device capable of producing a three-dimensional image.

### SUMMARY OF THE INVENTION

Accordingly, the present invention provides a novel method for creating, processing, modifying and producing three-dimensional images and objects of prenatal mammals using an ultrasonic diagnostic device.

It is a further object of the present invention to provide a method for providing three-dimensional images of prenatal mammals including the steps of scanning an expectant mother to obtain the three-dimensional images of the prenatal mammal at a non-medical facility, storing the three-dimensional images into an electronic medium, and providing the three-dimensional images stored in the electronic medium to a customer.

Furthermore, it is an object of the present invention to provide a method for providing three-dimensional images of prenatal mammals, wherein the prenatal mammal includes a human being and an animal.

It is a further object of the present invention to provide a method for obtaining three-dimensional images, wherein the images are scanned by using an ultrasonic device.

It is another object of the present invention to provide an electronic medium for storing the three-dimensional images, wherein the electronic medium includes CDROM's, diskettes, hard disks, mini disks, videotapes, and photographs.

It is another object of the present invention to provide the three-dimensional images to a customer by mail, Internet, and in person.

It is a further object of the present invention to provide a method for producing an article containing a three-dimensional image of prenatal mammals including collecting information containing the three-dimensional image of the prenatal mammals by using a first electronic device at a non-medical facility, transferring the collected information into a second electronic device, storing the information in the second electronic device, processing the stored information, and producing an article containing the three dimensional image from the collected information.

Another object of the present invention is to provide a method for collecting information containing the three-dimensional image of prenatal mammals by using an ultrasonic device.

Another object of the present invention is to provide a method for storing information in an electronic medium, wherein the electronic medium comprises CDROM's, diskettes, hard disks, mini disks, videotapes, and photographs.

It is a further object of the present invention to provide a method for producing the three-dimensional article in the form of a sculpture, or a piece of jewelry such as a pendant.

It is another object of the present invention is to provide a system for providing three-dimensional images of prenatal mammals, including a scanning device to electronically scan prenatal mammals form an expectant mother, a processing device for processing the scanned information, and a data storage for storing the processed information for the three-dimensional images of the prenatal mammals, the processed information including identifying the prenatal mammals and the expectant mother.

It is another object of the present invention to provide a system for providing three-dimensional images or prenatal mammals, wherein the scanning device includes an ultrasonic device capable of producing three-dimensional images.

It is another object of the present invention to provide an order-receiving device for receiving an order to purchase an article containing three-dimensional images of prenatal mammals.

It is another object of the present invention to provide an order receiving device that includes a server adapted to host a web-site to electronically receive an order to purchase an article from a customer.

It is a further object of the present invention to provide a system for providing three-dimensional images wherein the order-receiving device includes a customer call center adapted to receive by telephone, an order to purchase an article from a customer.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide further understanding of the invention and are incorporated in and constitute a part of this specification, illustrate embodiments of the invention and together with the description serve to explain the principles of the invention.

In the drawings:

FIG. 1 illustrates the process of scanning three-dimensional images of a prenatal mammal from an expectant mother by means of an electronic device, and saving the three-dimensional images into a storage medium.

FIG. 2 illustrates an order-receiving device.

FIG. 3 illustrates a method for further processing the three-dimensional images of the prenatal mammal.

### DETAILED DESCRIPTION OF THE INVENTION

A method for providing three-dimensional images of prenatal mammals has been developed, that includes scanning an expectant mother to obtain the three-dimensional images of the prenatal mammals at a non-medical facility, storing the three-dimensional images into an electronic medium, and providing the three-dimensional images stored in the electronic medium to a customer.

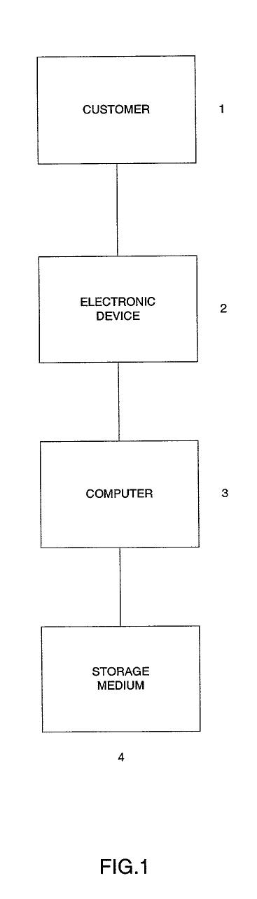

As illustrated in FIG. 1, the method includes, an expectant mother (1) traveling to a non-medical facility such as a retail store, photo-shop, or any other retail outlet, where an electronic device for obtaining three-dimensional images of a prenatal mammal is located. At this location, the expectant mother is scanned by means of the electronic device (2) such as an ultrasonic device, and the three-dimensional images of the prenatal mammal are generated and transferred to a computer (3) for further processing. Once the three-dimensional images of the prenatal mammal have been captured in the computer (3), the three-dimensional images are transferred to a separate storage medium (4), such as a CDROM, a diskette, a hard disk, mini disc, videotapes, photographs, etc, and delivered to the expectant mother or customer. Alternatively, the image of the prenatal mammal can be delivered to the customer or expectant mother by other means such as mail, or the Internet.

If the images are converted into an electronic file, the three-dimensional images of the mammals may be easily incorporated into other electronic material. For example, the three-dimensional images may be inserted in text-based documents or attached to email messages.

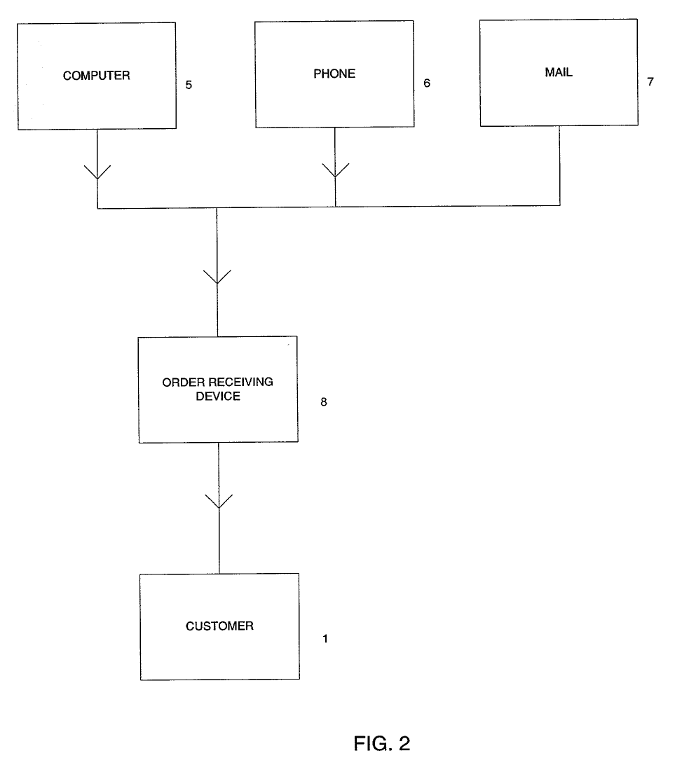

FIG. 2 illustrates a method and device for purchasing additional copies of the three-dimensional images. For example, a customer or expectant mother (1) contacts an order-receiving device (8) and submits an order. Although there are many means for contacting the order-receiving device, FIG. 2 illustrates a computer system (5), a phone system (6), and mail, as means for contacting the order-receiving device. If a computer system is used to contact the order-receiving device, a server hosting a web-site enables the customer to place the order.

Additionally, other order receiving devices can be set up for receiving customer requests such as a customer call center adapted to receive phone calls. Once the order has been completed, the order is delivered to the customer by a plurality of means such as Internet or mail.

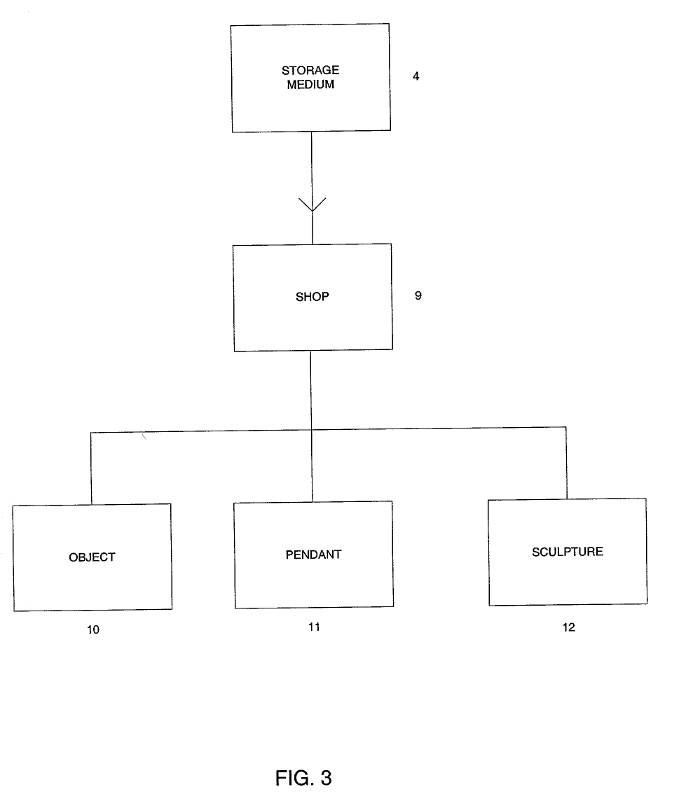

FIG. 3 illustrates an additional method and device for processing the three-dimensional images of the mammal. In one example, the customer brings the storage medium (4) to a specialty shop (9) and requests that the three-dimensional images of the prenatal mammal be printed on a particular object (10) such as clothing, coffee mugs, etc. Furthermore, the customer can request that the three-dimensional image of the prenatal mammal be reproduced in the form of a sculpture (11), pendant (12), etc.

Alternatively, the customer can request further processing of the three-dimensional images by Internet, mail, or phone as discussed above.

While the invention has been described in detail and with reference to specific embodiments thereof, it will be apparent to one skilled in the art that various changes and modification can be made therein without departing from the spirit or scope thereof. Thus, it is intended that the present invention covers the modifications and variations of this invention provided they come within the scope of the appended claims and their equivalents.

What is claimed is:

1. A method for providing three-dimensional images of prenatal mammals, comprising:
scanning an expectant mother to obtain the three-dimensional images of the prenatal mammals at a non-medical facility;
storing the three-dimensional images into an electronic medium; and
providing the three-dimensional images stored in the electronic medium to a customer.

2. The method according to claim 1, wherein the prenatal mammal includes a human being and an animal.

3. The method according to claim 1, wherein the three-dimensional images are scanned by using an ultrasonic device.

4. The method according to claim 1, wherein the electronic medium includes one of a CDROM, a diskette, a hard disk, a mini disk, a videotape, and a photograph.

5. The method according to claim 1, wherein the three-dimensional images are provided to the consumer by one of mail, internet, and in person.

6. A method for producing an article containing a three-dimensional image of prenatal mammals, comprising:
collecting information containing the three-dimensional image of prenatal mammals by using a first electronic device at a non-medical facility;
transferring the collected information into a second electronic device;
storing the information in the second electronic device;
processing the stored information; and
producing the article containing the three dimensional image from the collected information.

7. The method according to claim 6, wherein the first electronic device includes an ultrasonic device.

8. The method according to claim 6, wherein the stored information is saved in an electronic medium.

9. The method according to claim 8, wherein the electronic medium includes one of a CDROM, a diskette, a hard disk, a mini disk, a videotape, and a photograph.

10. The method according to claim 6, wherein the produced article includes one of a sculpture and a pendant.

11. A system for providing three-dimensional images of prenatal mammals, comprising:
a scanning device to electronically scan a prenatal mammal from an expectant mother;
a processing device to process the scanned information; and
a data storage to store the processed information for the three-dimensional images of the prenatal mammals, the processed information including identifying the prenatal mammals and the expectant mother.

12. The system according to claim 11, wherein the scanning device includes an ultrasonic device capable of producing a three-dimensional images.

13. The system according to claim 11, further comprising an order receiving device to receive an order to purchase an article containing the three-dimensional images of the prenatal mammals.

14. The system according to claim 13, wherein the order receiving device includes a server adapted to host a web-site to electronically receive an order to purchase an article from a customer.

15. The system according to claim 13, wherein the order receiving device includes a customer call center adapted to receive, by telephone, an order to purchase an article from a customer.
